(19) United States
(12) Patent Application Publication
(10) Pub. No.: US 2025/0037031 A1
(43) Pub. Date: Jan. 30, 2025

(54) METHOD AND APPARATUSES FOR ADJUSTING MODEL, METHOD AND APPARATUS FOR TRANSMITTING INFORMATION, AND RELATED DEVICES

(71) Applicant: VIVO MOBILE COMMUNICATION CO., LTD., Dongguan (CN)

(72) Inventor: Bule SUN, Dongguan (CN)

(73) Assignee: VIVO MOBILE COMMUNICATION CO., LTD., Dongguan (CN)

(21) Appl. No.: 18/914,048

(22) Filed: Oct. 11, 2024

Related U.S. Application Data
(63) Continuation of application No. PCT/CN2023/088356, filed on Apr. 14, 2023.

(30) Foreign Application Priority Data
Apr. 15, 2022 (CN) 202210400175.6

(51) Int. Cl. G06N 20/00

(52) U.S. Cl. CPC G06N 20/00

(57) ABSTRACT

This application discloses a method and apparatuses for adjusting a model, a method and apparatus for transmitting information, and related devices. The method for adjusting a model includes: executing, by a first device, a model adjustment operation on a first Artificial Intelligence (AI) model. The model adjustment operation includes one of the following: finetuning the first AI model; switching the first AI model into a second AI model; falling back to a target functional module for operation, where the target functional module is a module that does not use an AI model; finetuning the first AI model, and switching the first AI model into a second AI model; finetuning the first AI model, and falling back to the target functional module for operation; or stopping execution of a first function, where the first function is a function that is completed by the first AI model.

### CROSS-REFERENCE TO RELATED APPLICATIONS

This application is a continuation of International Application No. PCT/CN 2023/088356, filed on Apr. 14, 2023, which claims the priority of Chinese Patent Application No. 202210400175.6 filed in China on Apr. 15, 2022. The entire contents of each of the above-referenced applications are expressly incorporated herein by reference.

### TECHNICAL FIELD

This application belongs to the technical field of communications, and in particular, to a method and apparatuses for adjusting a model, a method and apparatus for transmitting information, and related devices.

### BACKGROUND

Artificial Intelligence (Artificial Intelligence, AI) has been widely applied in various fields. There are various implementation modes for AI models, such as a neural network, a decision tree, a support vector machine, and a Bayesian classifier. At present, the AI models are widely used in wireless communication systems. As a user equipment moves, a wireless environment changes, and an executed service changes, the effectiveness of the models may also change, or even fail. The changes in the AI models may cause stagnation or low efficiency of functional modules in the wireless communication systems. This affects the system performance.

### SUMMARY

Embodiments of this application provide a method and apparatuses for adjusting a model, a method and apparatus for transmitting information, and related devices.

In a first aspect, a method for adjusting a model is provided. The method includes:
executing, by a first device, a model adjustment operation on a first Artificial Intelligence (AI) model, where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a second aspect, a method for adjusting a model is provided. The method includes:
receiving, by a second device, first information sent by a first device, where the first information is used for indicating a model adjustment operation executed by the first device on a first AI model;
or, sending, by the second device, second information to the first device, where the second information is used for indicating the model adjustment operation executed by the first device on the first AI model,
where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a third aspect, an apparatus for adjusting a model is provided. The method includes:
an adjustment module, configured to execute a model adjustment operation on a first AI model, where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a fourth aspect, an apparatus for adjusting a model is provided, including the following:
a first receiving module, configured to receive first information sent by a first device, where the first information is used for indicating a model adjustment operation executed by the first device on a first AI model;
or,
a first sending module, configured to send second information to the first device, where the second information is used for indicating the model adjustment operation executed by the first device on the first AI model,
where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a fifth aspect, a first device is provided, including a processor and a communication interface. The processor is configured to execute a model adjustment operation on a first AI model. The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a sixth aspect, a second device is provided, including a processor and a communication interface. The communication interface is configured to: receive first information sent by a first device, where the first information is used for indicating a model adjustment operation executed by the first device on a first AI model; or, send second information to the first device, where the second information is used for indicating the model adjustment operation executed by the first device on the first AI model,
where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

In a seventh aspect, a communication system is provided, including: a first device and a second device, where the first device is configured to perform the method of the first aspect, and the second device is configured to perform the method of the second aspect.

In an eighth aspect, a first device is provided, including a processor and a memory. The memory stores programs or instructions runnable on the processor, and the programs or instructions, when executed by the processor, implement the method for adjusting a model as described in the first aspect.

In a ninth aspect, a second device is provided, including a processor and a memory. The memory stores programs or instructions runnable on the processor, and the programs or instructions, when executed by the processor, implement the method for adjusting a model as described in the second aspect.

In a tenth aspect, a readable storage medium is provided, having programs or instructions stored thereon. The programs or instructions, when executed by a processor, implement the steps of the method as described in the first aspect or the second aspect.

In an eleventh aspect, a chip is provided. The chip includes a processor and a communication interface. The communication interface is coupled with the processor, and the processor is configured to run programs or instructions to implement the steps of the method as described in the first aspect or the second aspect.

In a twelfth aspect, a computer program/program product is provided. The computer program/program product is stored in a storage medium. The computer program/program product is executed by at least one processor to implement the steps of the method as described in the first aspect or the second aspect.

In the embodiments of this application, the first device may execute a model adjustment operation on a first AI model. By finetuning the first AI model, or switching the first AI model into a second AI model, or fallback to a target functional module, or another operation, low-efficiency operation or stagnation of the device caused by a change in the effectiveness of a model can be effectively avoided, thereby improving the performance of the device.

### BRIEF DESCRIPTION OF THE DRAWINGS

FIG. 1 is a block diagram of a wireless communication system applicable to an embodiment of this application;

FIG. 2 is a flowchart I of a method for adjusting a model provided by an embodiment of this application;

FIG. 3 is a flowchart of a method for transmitting information according to an embodiment of this application;

FIG. 4a is a flowchart II of a method for adjusting a model provided by an embodiment of this application;

FIG. 4b is a flowchart III of a method for adjusting a model provided by an embodiment of this application;

FIG. 4c is a flowchart IV of a method for adjusting a model provided by an embodiment of this application;

FIG. 4d is a flowchart V of a method for adjusting a model provided by an embodiment of this application;

FIG. 5 is a structural diagram of an apparatus for adjusting a model according to an embodiment of the this application;

FIG. 6 is a structural diagram of an apparatus for transmitting information according to an embodiment of this application;

FIG. 7 is a structural diagram of a user equipment provided by an embodiment of this application;

FIG. 8 is a structural diagram of a communication device provided by an embodiment of this application; and

FIG. 9 is a structural diagram of a network side device provided by an embodiment of this application.

### DETAILED DESCRIPTION

The technical solutions in embodiments of this application are clearly described in the following with reference to the accompanying drawings in the embodiments of this application. Apparently, the described embodiments are merely some rather than all of the embodiments of this application. All other embodiments obtained by those of ordinary skill in the art based on the embodiments of this application fall within the protection scope of this application.

Terms such as “first” and “second” in the description and claims of this application are used for distinguishing similar objects, instead of describing a specific sequence or order. It should be understood that terms used like this are interchangeable where appropriate, so that the embodiments of this application can be implemented in a sequence other than those illustrated or described here. Furthermore, objects distinguished by “first” and “second” are usually of the same class and the number of the objects is not limited. For example, the first object may be one or more. In addition, “and/or” used in the description and claims represents at least one of the connected objects. Symbol “/” usually represents an “or” relationship between front and back associated objects.

It is worth noting that the technologies described in the embodiments of this application are not limited to a Long Term Evolution (LTE)/LTE-Advanced (LTE-A) system, and may further be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the described technologies may be applied to both the aforementioned systems and radio technologies, as well as other systems and radio technologies. The following describes a New Radio (NR) system for the example purpose and uses the term NR in most of the following descriptions. However, these technologies may further be applied to applications other than the NR system application, such as a 6^{th} Generation (6G) communication system.

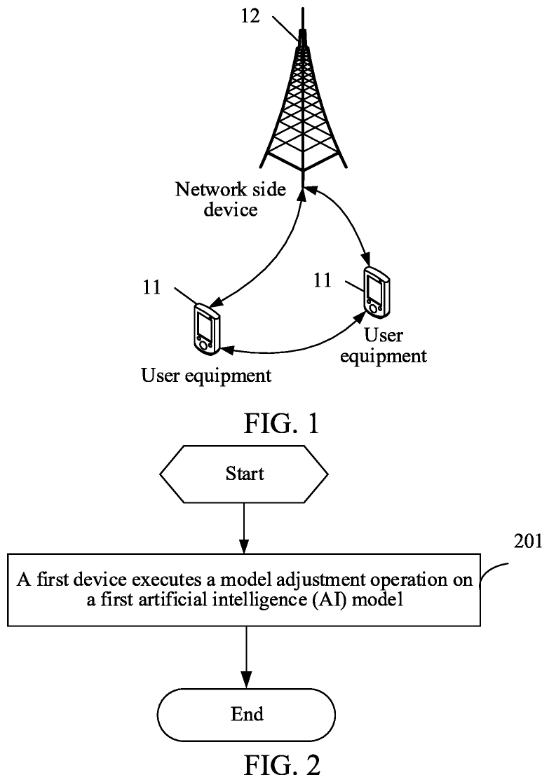

FIG. 1 shows a block diagram of a wireless communication system applicable to an embodiment of this application. The wireless communication system includes a user equipment 11 and a network side device 12. The user equipment 11 may be a user equipment side device, such as a mobile phone, a tablet personal computer, a laptop computer or a notebook computer, a Personal Digital Assistant (PDA), a handheld computer, a netbook, an Ultra-mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (home devices with wireless communication functions, such as a refrigerator, a television, a washing machine, or furniture), a game console, a Personal Computer (PC), an automated teller machine, or a self-service machine. The wearable device includes: a smart watch, a smart hand ring, a smart headphone, smart glasses, a smart jewelry (a smart bracelet, a smart chain bracelet, a smart ring, a smart necklace, a smart anklet, a smart chain anklet, and the like), a smart wristband, smart clothing, and the like. It should be noted that, in the embodiments of this application, a specific type of the user equipment 11 is not limited. The network side device 12 may include an access network device or a core network device. The access network device may also be referred to as a wireless access network device, a Radio Access Network (RAN), a wireless access network function, or a wireless access network unit. The access network device may include a base station, a Wireless Local Area Networks (WLAN) access point, a WiFi node, or the like. The base station may be referred to as a node B, an evolved node B (eNB), an access point, a Base Transceiver Station (BTS), a radio base station, a radio transceiver, a Basic Service Set (BSS), an Extended Service Set (ESS), a home node B, a home evolved node B, a Transmitting Receiving Point (TRP), or some other suitable term in the art, as long as the same technical effects are achieved. The base station is not limited to a particular technical vocabulary. It should be noted that, in the embodiments of this application, description is made by using only the base station in the NR system as an example, but a specific type of the base station is not limited.

Methods provided by embodiments of this application will be described below in detail through some embodiments and their application scenarios in conjunction with the accompanying drawings.

As shown in FIG. 2, an embodiment of this application provides a method for adjusting a model, including the following step:
Step 201. A first device executes a model adjustment operation on a first AI model. The model adjustment operation includes one of the following:
(1) finetuning the first AI model;
(2) switching the first AI model into a second AI model, where this may be understood as stopping operating the first AI model, and operating the second AI model; the second AI model is a model defined based on a protocol, or a model received by the first device from a second device, or a model obtained by training the first device; for example, the first AI model and the second AI model may achieve the same function;
(3) fallback to a target functional module for operation, where the target functional module is a module that does not use an AI model; the target functional module may be indicated by a protocol, or indicated by the second device; for example, the target functional module and the first AI model may achieve the same function;
(4) finetuning the first AI model, and switching the first AI model into the second AI model;
(5) finetuning the first AI model, and fallback to the target functional module for operation; and
(6) stopping execution of a first function, where the first function is a function that is completed by the first AI model.

For example, the first device may be a user equipment. The model adjustment operation may be determined by the first device itself or executed based on an indication of the second device. The second device may be a network side device. For example, the network side device sends, to the first device, second information used for indicating the model adjustment operation, and the first device executes the model adjustment operation on the first AI model based on the second information.

The model adjustment operation may be finetuning the first AI model, or switching the first AI model to the second AI model, or fallback to the target functional module for operation. In addition, the finetuning on the first AI model may also be executed in parallel with the other two solutions, namely, finetuning the first AI model and switching the first AI model to the second AI model, or finetuning the first AI model and fallback to the target functional module for operation. Further, the first device may also stop execution of a first function. The first function is a function completed by the first AI model. For example, as a function achieved by some AI models is an auxiliary function, stopping the execution of this function does not affect the operation of the system. In this case, this function may not be executed, namely, the execution of the function is stopped.

When the effectiveness of the first AI model changes, the first device executes the model adjustment operation. For example, when the first AI model fails, the first device executes the model adjustment operation.

In this embodiment, the first device executes the model adjustment operation on the first AI model. For example, when the effectiveness of the first AI model changes, by adjusting the first AI model, or switching the first AI model into the second AI model, or fallback to the target functional module, or another operation, low-efficiency operation or stagnation of the device caused failure of the model can be effectively avoided, thereby improving the performance of the device.

In an embodiment of this application, the first device executes a model adjustment operation on a first AI model, which includes the following: The first device determines, based on a preset condition, that the first AI model fails, and executes the model adjustment operation on the first AI model.

The preset condition includes the following: first performance of the first AI model satisfies a first condition, or second performance of the first AI model satisfies a second condition, where an AI model with high first performance is superior to an AI model with low first performance, and an AI model with low second performance is superior to an AI model with high second performance.

For example, before the executing a model adjustment operation on a first AI model, the first device may determine whether the first AI model fails, for example, determine whether the first AI model satisfies the preset condition. The first performance or the second performance may be used for representing the performance of the first AI model. A larger value of the first performance indicates that the performance of the first AI model is better, and a smaller value of the second performance indicates that the performance of the first AI model is better. The first performance may be accuracy, a similarity, correctness, a hit rate, coverage, efficiency, spectral efficiency, a throughput, a capacity, and the like. The second performance may be an error, a mean square error, a normalized mean square error, a Bit Error Ratio (BER), a Block Error Probability (BLER), a call drop rate, a false switching probability, and the like.

The preset condition may be defined by a protocol or sent by the second device to the first device.

The first performance or the second performance may be determined based on an output result of the first AI model. In this case, the output result of the first AI model is a final result. For example, if the first AI model is a model for calculating accuracy, the output result of the first AI model is the final result. The first performance may be determined according to the output result of the first AI model. Or, the first performance may be determined based on a result obtained by inputting the output result of the first AI model to another functional module. In this case, the output result of the first AI model is regarded as an intermediate result.

The first condition includes one of the following:
(1) the first performance of the first AI model is less than or equal to a first threshold;
(2) a first statistic number of times is greater than or equal to a first preset number-of-times threshold, where the first statistic number of times is a number of times at which the first performance of the first AI model is less than or equal to a second threshold within a first target preset time period;
(3) a second statistic number of times is less than or equal to a second preset number-of-times threshold, where the second statistic number of times is a number of times at which the first performance of the first AI model is greater than or equal to a third threshold within a second target preset time period;
(4) first time is less than or equal to a first time threshold, where the first time is a duration during which the first performance of the first AI model is greater than or equal to a fourth threshold; and
(5) second time is greater than or equal to a second time threshold, where the second time is a duration during which the first performance of the first AI model is less than or equal to a fifth threshold.

The second condition includes one of the following:
(1) the second performance of the first AI model is greater than or equal to a sixth threshold;
(2) a third statistic number of times is greater than or equal to a third preset number-of-times threshold, where the third statistic number of times is a number of times at which the second performance of the first AI model is greater than or equal to a seventh threshold within a third target preset time period;
(3) a fourth statistic number of times is less than or equal to a fourth preset number-of-times threshold, where the fourth statistic number of times is a number of times at which the second performance of the first AI model is less than or equal to an eighth threshold within a fourth target preset time period;
(4) third time is less than or equal to a third time threshold, where the third time is a duration during which the second performance of the first AI model is less than or equal to a ninth threshold; and
(5) fourth time is greater than or equal to a fourth time threshold, where the fourth time is a duration during which the second performance of the first AI model is greater than or equal to a tenth threshold.

In an embodiment of this application, the method further includes the following: The first device sends failure confirmation information to a second device when the first AI model fails. The failure confirmation information is used for indicating failure information of the first AI model. The failure confirmation information includes at least one of the following:
(1) a failure state of the first AI model, namely, the model failure is true;
(2) performance information when the first AI model fails;
(3) a failure cause of the first AI model;
(4) failure time of the first AI model; and
(5) a first duration of the first AI model, where the first duration is a time length from the beginning of the operation of the first AI model to the failure of the first AI model.

In an embodiment of this application, after the first device executes the model adjustment operation on the first AI model, the method further includes the following:

When the model adjustment operation is determined by the first device, the first device sends first information to the second device. The first information is used for indicating the model adjustment operation executed by the first device. Namely, the first device may inform, through the first information, the second device of the model adjustment operation used by the first device.

In an embodiment of this application, after the first device executes the model adjustment operation on the first AI model, the method further includes the following:
The first device executes a replacement operation based on a triggering condition;
or,
the first device sends third information to the second device based on the triggering condition; the first device receives indication information sent by the second device; and the first device determines, according to the indication information, whether to execute the replacement operation, where the third information is used for indicating that the first device satisfies a condition for executing the replacement operation, and the indication information is used for indicating the first device to execute or not execute the replacement operation.

The replacement operation includes:
when the model adjustment operation includes finetuning the first AI model and switching the first AI model into the second AI model, stopping operating the second AI model, and operating a third AI model, where the third AI model is a model obtained after the first AI model is finetuned;
or,
when the model adjustment operation includes finetuning the first AI model and fallback to the target functional module for operation, stopping operating the target functional module, and operating the third AI model.

After executing the replacement operation, the first device further sends information to inform the second device, namely, the first device further sends replacement information to the second device. The replacement information is used for indicating information related to the replacement operation. For example, the replacement information is used for indicating information that the first device has stopped operating the second AI model and is operating the third AI model, or the replacement information is used for indicating information that the first device has stopped operating the target functional module and is operating the third AI model.

In an embodiment, the triggering condition includes one of the following:
a difference value between first performance of the third AI model and first performance of a target object is greater than or equal to a first threshold, where the target object is the second AI model or the target functional module, and an AI model with high first performance is superior to an AI model with low first performance;
a first number of times is greater than or equal to a first number-of-times threshold, where the first number of times is a number of times at which the difference value between the first performance of the third AI model and the first performance of the target object is greater than or equal to a second threshold within a first preset time period;
a second number of times is less than or equal to a second number-of-times threshold, where the second number of times is a number of times at which the difference value between the first performance of the third AI model and the first performance of the target object is less than or equal to a third threshold within a second preset time period;
a second duration is greater than or equal to a first time threshold, where the second duration is a duration during which the difference value between the first performance of the third AI model and the first performance of the target object is greater than or equal to a fourth threshold;
a third duration is less than or equal to a second time threshold, where the third duration is a duration during which the difference value between the first performance of the third AI model and the first performance of the target object is less than or equal to a fifth threshold;
a ratio of the first performance of the third AI model to the first performance of the target object is greater than or equal to a sixth threshold;
a third number of times is greater than or equal to a third number-of-times threshold, where the third number of times is a number of times at which the ratio of the first performance of the third AI model to the first performance of the target object is greater than or equal to a seventh threshold within a third preset time period;
a fourth number of times is less than or equal to a fourth number-of-times threshold, where the fourth number of times is a number of times at which the ratio of the first performance of the third AI model to the first performance of the target object is less than or equal to an eighth threshold within a fourth preset time period;
a fourth duration is greater than or equal to a third time threshold, where the fourth duration is a duration during which the ratio of the first performance of the third AI model to the first performance of the target object is greater than or equal to a ninth threshold; and
a fifth duration is less than or equal to a fourth time threshold, where the fifth duration is a duration during which the ratio of the first performance of the third AI model to the first performance of the target object is less than or equal to a tenth threshold.

In another embodiment, the triggering condition includes one of the following:
a difference value between second performance of the third AI model and second performance of a target object is less than or equal to an eleventh threshold, where the target object is the second AI model or the target functional module, and an AI model with low second performance is superior to an AI model with high second performance;
a fifth number of times is greater than or equal to a fifth number-of-times threshold, where the fifth number of times is a number of times at which the difference value between the second performance of the third AI model and the second performance of the target object is less than or equal to a twelfth threshold within a fifth preset time period;
a sixth number of times is less than or equal to a sixth number-of-times threshold, where the sixth number of times is a number of times at which the difference value between the second performance of the third AI model and the second performance of the target object is greater than or equal to a thirteenth threshold within a sixth preset time period;
a sixth duration is greater than or equal to a fifth time threshold, where the sixth duration is a duration during which the difference value between the second performance of the third AI model and the second performance of the target object is greater than or equal to a fourteenth threshold;
a seventh duration is less than or equal to a sixth time threshold, where the seventh duration is a duration during which the difference value between the second performance of the third AI model and the second performance of the target object is greater than or equal to a fifteenth threshold;
a ratio of the second performance of the third AI model to the second performance of the target object is less than or equal to a sixteenth threshold;
a seventh number of times is greater than or equal to a seventh number-of-times threshold, where the seventh number of times is a number of times at which the ratio of the second performance of the third AI model to the second performance of the target object is less than or equal to a seventeenth threshold within a seventh preset time period;
an eighth number of times is less than or equal to an eighth number-of-times threshold, where the eighth number of times is a number of times at which the ratio of the second performance of the third AI model to the second performance of the target object is less than or equal to an eighteenth threshold within an eighth preset time period;
an eighth duration is greater than or equal to a seventh time threshold, where the eighth duration is a duration during which the ratio of the second performance of the third AI model to the second performance of the target object is less than or equal to a nineteenth threshold; and
a ninth duration is less than or equal to an eighth time threshold, where the ninth duration is a duration during which the ratio of the second performance of the third AI model to the second performance of the target object is greater than or equal to a twentieth threshold.

In an embodiment of this application, when the first device is a user equipment, and the second device is a network side device, target information sent by the first device to the second device is carried in one of the following signalings or information:
a layer-1 signaling of a Physical Uplink Control Channel (PUCCH);
a message (MSG) 1 of a Physical Random Access Channel (PRACH);
MSG 3 of the PRACH;
MSG A of the PRACH; and
information of a Physical Uplink Shared Channel (PUSCH).

The target information includes the failure confirmation information, the first information, or the replacement information.

In an embodiment of this application, when the first device is a user equipment, and the second device is a network side device, second information sent by the second device to the first device is carried in one of the following signalings or information, and the second information is used for indicating the model adjustment operation:
a Medium Access Control Control Element (MAC CE);
a Radio Resource Control (RRC) message;
a Non-Access-Stratum (NAC) message;
a management and orchestration message;
user plane data;
Downlink Control Information (DCI);
System Information Block (SIB);
a layer-1 signaling of a Physical Downlink Control Channel (PDCCH);
information of a Physical Downlink Shared Channel (PDSCH);
MSG 2 of a PRACH;
MSG 4 of the PRACH; and
MSG B of the PRACH.

In an embodiment of this application, when the first device is a first user equipment, and the second device is a second user equipment, a target message sent by the first device to the second device is carried in one of the following signalings or information:
an Xn interface signaling;
a PC5 interface signaling;
information of a Physical SideLink Control Channel (PSCCH);
information of a Physical SideLink Shared Channel (PSSCH);
information of a Physical SideLink Broadcast Channel (PSBCH);
information of a Physical SideLink Discovery Channel (PSDCH); and
information of a Physical SideLink Feedback Channel (PSFCH).

The target information includes the failure confirmation information, the first information, or the replacement information.

In an embodiment of this application, when the first device is a first user equipment, and the second device is a second user equipment, second information sent by the second device to the first device is carried in one of the following signalings or information, and the second information is used for indicating the model adjustment operation:
an Xn interface signaling;
a PC5 interface signaling;
information of a PSCCH;
information of a PSSCH;
information of a PSBCH;
information of a PSDCH; and
information of a PSFCH.

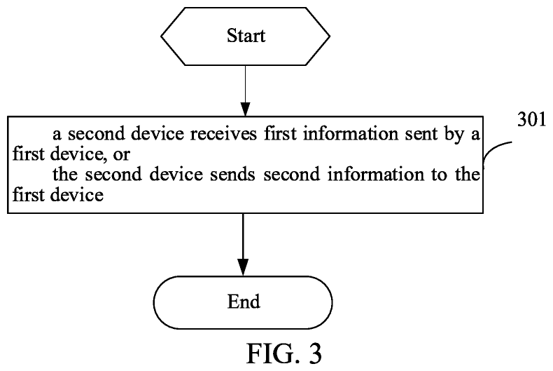

As shown in FIG. 3, an embodiment of this application provides a method for transmitting information, including the following step:
Step 301. A second device receives first information sent by a first device. The first information is used for indicating a model adjustment operation executed by the first device on a first AI model;
or, the second device sends second information to the first device, where the second information is used for indicating the model adjustment operation executed by the first device on the first AI model.

The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

For example, the first device may be a user equipment, and the model adjustment operation may be determined by the first device itself. If the model adjustment operation is determined by the first device itself, the first device may send the first information to the second device to inform the second device of the model adjustment operation used by the first device.

The model adjustment operation may also be executed based on an indication of the second device. For example, the second device sends, to the first device, the second information used for indicating the model adjustment operation, and the first device executes the model adjustment operation on the first AI model based on the second information.

The model adjustment operation may be finetuning the first AI model, or switching the first AI model to the second AI model, or fallback to the target functional module for operation. In addition, the finetuning on the first AI model may also be executed in parallel with the other two solutions, namely, finetuning the first AI model and switching the first AI model to the second AI model, or finetuning the first AI model and fallback to the target functional module for operation. Further, the first device may also stop execution of a first function. The first function is a function completed by the first AI model. For example, as a function achieved by some AI models is an auxiliary function, stopping the execution of this function does not affect the operation of the system. In this case, this function may not be executed, namely, the execution of the function is stopped.

In this embodiment, the second device may send, to the first device, the second information used for indicating the model adjustment operation, so that the first device executes the model adjustment operation on the first AI model. For example, by finetuning the first AI model, or switching the first AI model into a second AI model, or fallback to a target functional module, or another operation, low-efficiency operation or stagnation of the first device caused by a change in the effectiveness of the model can be effectively avoided, thereby improving the performance of the device. In addition, the first device may also determine the model adjustment operation itself and inform the second device of the executed model adjustment operation.

In an embodiment of this application, the method further includes the following: The second device receives failure confirmation information sent by the first device. The failure confirmation information is used for indicating failure information of the first AI model. The failure confirmation information includes at least one of the following:
a failure state of the first AI model;
performance information when the first AI model fails;
a failure cause of the first AI model;
failure time of the first AI model; and
a first duration of the first AI model, where the first duration is a time length from the beginning of the operation of the first AI model to the failure of the first AI model.

In an embodiment of this application, the method further includes the following: The second device receives replacement information sent by the first device. The replacement information is used for indicating information related to a replacement operation executed by the first device.

The replacement operation includes:
when the model adjustment operation includes finetuning the first AI model and switching the first AI model into the second AI model, stopping operating the second AI model, and operating a third AI model, where the third AI model is a model obtained after the first AI model is finetuned;
or,
when the model adjustment operation includes finetuning the first AI model and fallback to the target functional module for operation, stopping operating the target functional module, and operating the third AI model.

In an embodiment of this application, when the first device is a user equipment, and the second device is a network side device, target information sent by the first device to the second device is carried in one of the following signalings or information:
a layer-1 signaling of a PUCCH;
MSG 1 of a PRACH;
MSG 3 of the PRACH;
MSG A of the PRACH; and
information of a PUSCH.

The target information includes the failure confirmation information, the first information, or the replacement information.

In an embodiment of this application, when the first device is a first user equipment, and the second device is a second user equipment, a target message sent by the first device to the second device is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The target information includes the failure confirmation information, the first information, or the replacement information.

In an embodiment of this application, when the first device is a user equipment, and the second device is a network side device, the second information is carried in one of the following signalings or information:
a MAC CE;
a RRC message;
a NAS message;
a management and orchestration message;
user plane data;
DCI;
a SIB;
a layer-1 signaling of a PDCCH;
information of a PDSCH;
MSG 2 of the PRACH;
MSG 4 of the PRACH; and
MSG B of the PRACH.

In an embodiment of this application, when the first device is a first user equipment, and the second device is a second user equipment, the second information is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The method provided by this application will be illustrated below.

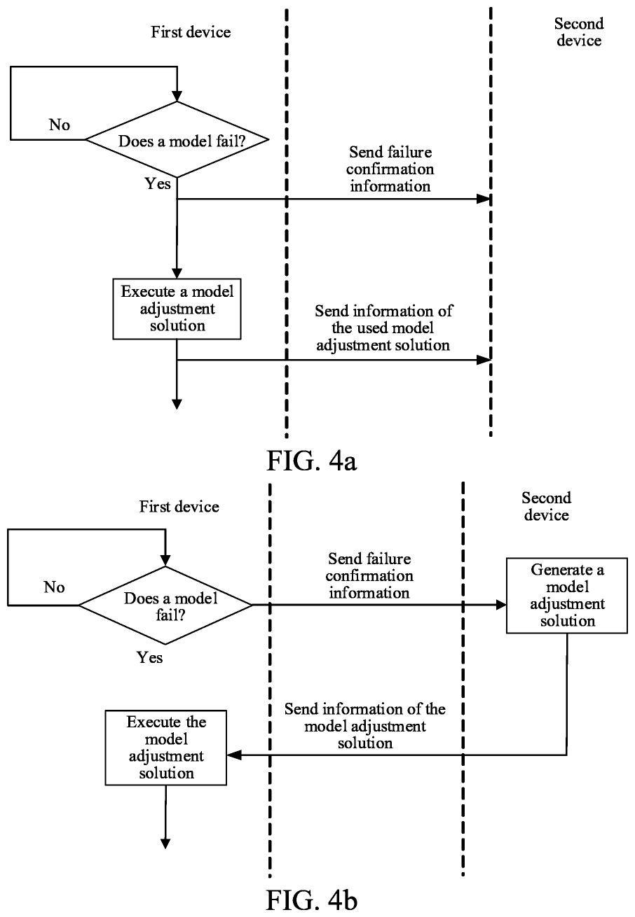

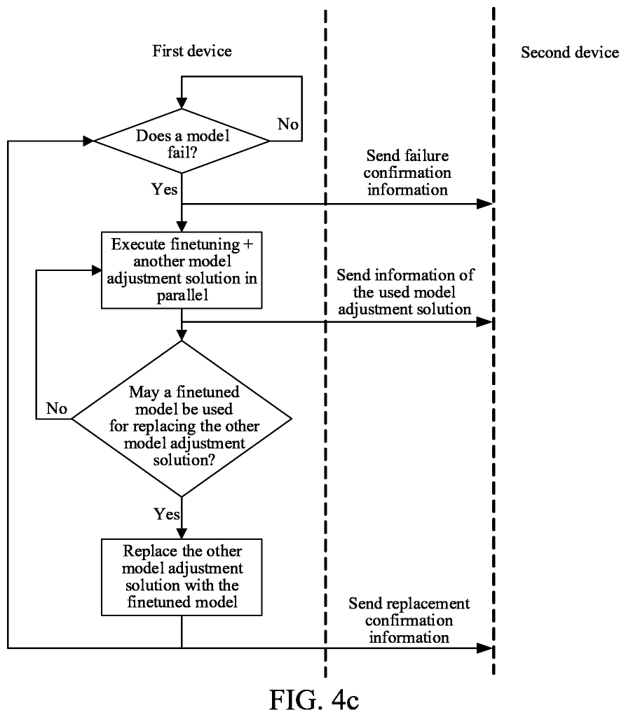

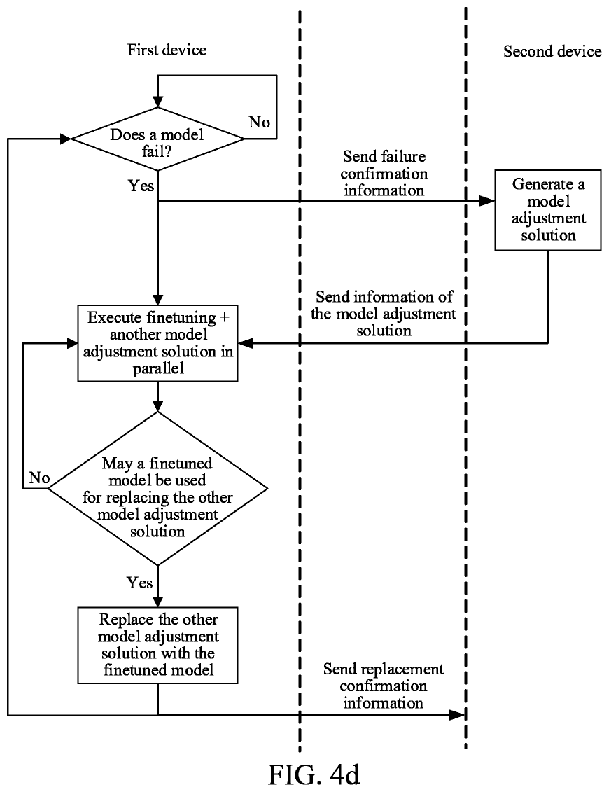

FIG. 4a shows a schematic flowchart of the first device determining the model adjustment operation itself. As shown in FIG. 4a, the following steps are included:

The first device determines whether the first AI model fails. If the first AI model fails, the first device sends failure confirmation information to the second device, executes a model adjustment solution, namely, executes the model adjustment operation on the first AI model, and sends the used model adjustment solution to the second device.

FIG. 4b shows a schematic flowchart of the second device determining the model adjustment operation. As shown in FIG. 4b, the following steps are included:

The first device determines whether the first AI model fails. If the first AI model fails, the first device sends failure confirmation information to the second device, and the second device determines a model adjustment solution. The second device sends the model adjustment solution to the first device, and the first device executes the model adjustment solution.

FIG. 4c shows a schematic flowchart of the first device determining the model adjustment operation itself and executing the replacement operation. As shown in FIG. 4c, the following steps are included:

The first device determines whether the first AI model fails. If the first AI model fails, the first device sends failure confirmation information to the second device and executes a model adjustment solution. The model adjustment solution includes finetuning the first AI model and another model adjustment solution. The other model adjustment solution includes switching to the second AI model, or fallback to the target functional module.

The first device further sends information of the used model adjustment solution to the second device.

Further, the first device determines whether to replace another model with the finetuned model, for example, to replace the second AI model or the target functional module with the finetuned model. If yes, the finetuned model is used to replace the model or functional module in the other model adjustment solution. Otherwise, the finetuning operation and the other model adjustment solution are executed.

After executing the replacement operation, the first device further sends replacement confirmation information (i.e. the aforementioned replacement information) to the second device.

FIG. 4d shows a schematic flowchart of the second device determining the model adjustment operation and the first device executing the replacement operation. As shown in FIG. 4d, the following steps are included:

The first device determines whether the first AI model fails. If the first AI model fails, the first device sends failure confirmation information to the second device. The second device generates a model adjustment solution and sends the model adjustment solution to the first device. The model adjustment solution includes finetuning the first AI model and another model adjustment solution. The other model adjustment solution includes switching to the second AI model, or fallback to the target functional module.

The first device executes the model adjustment solution and determines whether to replace another model with the finetuned model, for example, to replace the second AI model or the target functional module with the finetuned model. If yes, the finetuned model is used to replace the model or functional module in the other model adjustment solution. Otherwise, the finetuning operation and the other model adjustment solution are executed.

After executing the replacement operation, the first device further sends replacement confirmation information (i.e. the aforementioned replacement information) to the second device.

The model failure determination process and the model adjustment process can avoid the problem of low-efficiency operation or stagnation of a system caused by the adjustment of a failed model, thereby improving the performance of the first device.

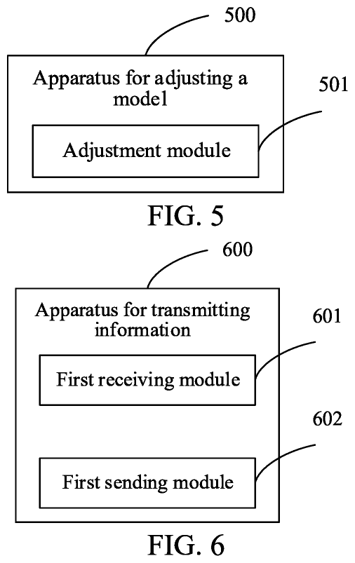

FIG. 5 shows an apparatus for adjusting a model according to an embodiment of this application. The apparatus 500 for adjusting a model includes:
an adjustment module 501, configured to execute a model adjustment operation on a first AI model, where the model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

For example, the adjustment module 501 is configured to determine, based on a preset condition, that the first AI model fails, and execute the model adjustment operation on the first AI model.

The preset condition includes the following: first performance of the first AI model satisfies a first condition, or second performance of the first AI model satisfies a second condition, where an AI model with high first performance is superior to an AI model with low first performance, and an AI model with low second performance is superior to an AI model with high second performance.

For example, the first condition includes one of the following:
the first performance of the first AI model is less than or equal to a first threshold;
a first statistic number of times is greater than or equal to a first preset number-of-times threshold, where the first statistic number of times is a number of times at which the first performance of the first AI model is less than or equal to a second threshold within a first target preset time period;
a second statistic number of times is less than or equal to a second preset number-of-times threshold, where the second statistic number of times is a number of times at which the first performance of the first AI model is greater than or equal to a third threshold within a second target preset time period;
first time is less than or equal to a first time threshold, where the first time is a duration during which the first performance of the first AI model is greater than or equal to a fourth threshold; and
second time is greater than or equal to a second time threshold, where the second time is a duration during which the first performance of the first AI model is less than or equal to a fifth threshold.

For example, the second condition includes one of the following:
the second performance of the first AI model is greater than or equal to a sixth threshold;
a third statistic number of times is greater than or equal to a third preset number-of-times threshold, where the third statistic number of times is a number of times at which the second performance of the first AI model is greater than or equal to a seventh threshold within a third target preset time period;
a fourth statistic number of times is less than or equal to a fourth preset number-of-times threshold, where the fourth statistic number of times is a number of times at which the second performance of the first AI model is less than or equal to an eighth threshold within a fourth target preset time period;
third time is less than or equal to a third time threshold, where the third time is a duration during which the second performance of the first AI model is less than or equal to a ninth threshold; and
fourth time is greater than or equal to a fourth time threshold, where the fourth time is a duration during which the second performance of the first AI model is greater than or equal to a tenth threshold.

For example, the apparatus 500 further includes a first sending module, configured to send failure confirmation information to a second device when the first AI model fails. The failure confirmation information is used for indicating failure information of the first AI model.

For example, the failure confirmation information includes at least one of the following:
a failure state of the first AI model;
performance information when the first AI model fails;
a failure cause of the first AI model;
failure time of the first AI model; and
a first duration of the first AI model, where the first duration is a time length from the beginning of the operation of the first AI model to the failure of the first AI model.

For example, the model adjustment operation is determined by the first device, or indicated by a second device.

For example, the apparatus 500 further includes a second sending module, configured to, when the model adjustment operation is determined by the first device, send first information to the second device, where the first information is used for indicating the model adjustment operation executed by the first device.

For example, the apparatus 500 further includes a replacement module, configured to execute a replacement operation based on a triggering condition. The replacement operation includes:
when the model adjustment operation includes finetuning the first AI model and switching the first AI model into the second AI model, stopping operating the second AI model, and operating a third AI model, where the third AI model is a model obtained after the first AI model is finetuned;
or,
when the model adjustment operation includes finetuning the first AI model and fallback to the target functional module for operation, stopping operating the target functional module, and operating the third AI model.

For example, the triggering condition includes one of the following:
a difference value between first performance of the third AI model and first performance of a target object is greater than or equal to a first threshold, where the target object is the second AI model or the target functional module, and an AI model with high first performance is superior to an AI model with low first performance;
a first number of times is greater than or equal to a first number-of-times threshold, where the first number of times is a number of times at which the difference value between the first performance of the third AI model and the first performance of the target object is greater than or equal to a second threshold within a first preset time period;
a second number of times is less than or equal to a second number-of-times threshold, where the second number of times is a number of times at which the difference value between the first performance of the third AI model and the first performance of the target object is less than or equal to a third threshold within a second preset time period;
a second duration is greater than or equal to a first time threshold, where the second duration is a duration during which the difference value between the first performance of the third AI model and the first performance of the target object is greater than or equal to a fourth threshold;
a third duration is less than or equal to a second time threshold, where the third duration is a duration during which the difference value between the first performance of the third AI model and the first performance of the target object is less than or equal to a fifth threshold;
a ratio of the first performance of the third AI model to the first performance of the target object is greater than or equal to a sixth threshold;
a third number of times is greater than or equal to a third number-of-times threshold, where the third number of times is a number of times at which the ratio of the first performance of the third AI model to the first performance of the target object is greater than or equal to a seventh threshold within a third preset time period;
a fourth number of times is less than or equal to a fourth number-of-times threshold, where the fourth number of times is a number of times at which the ratio of the first performance of the third AI model to the first performance of the target object is less than or equal to an eighth threshold within a fourth preset time period;
a fourth duration is greater than or equal to a third time threshold, where the fourth duration is a duration during which the ratio of the first performance of the third AI model to the first performance of the target object is greater than or equal to a ninth threshold; and
a fifth duration is less than or equal to a fourth time threshold, where the fifth duration is a duration during which the ratio of the first performance of the third AI model to the first performance of the target object is less than or equal to a tenth threshold.

For example, the triggering condition includes one of the following:
a difference value between second performance of the third AI model and second performance of a target object is less than or equal to an eleventh threshold, where the target object is the second AI model or the target functional module, and an AI model with low second performance is superior to an AI model with high second performance;
a fifth number of times is greater than or equal to a fifth number-of-times threshold, where the fifth number of times is a number of times at which the difference value between the second performance of the third AI model and the second performance of the target object is less than or equal to a twelfth threshold within a fifth preset time period;
a sixth number of times is less than or equal to a sixth number-of-times threshold, where the sixth number of times is a number of times at which the difference value between the second performance of the third AI model and the second performance of the target object is greater than or equal to a thirteenth threshold within a sixth preset time period;
a sixth duration is greater than or equal to a fifth time threshold, where the sixth duration is a duration during which the difference value between the second performance of the third AI model and the second performance of the target object is greater than or equal to a fourteenth threshold;
a seventh duration is less than or equal to a sixth time threshold, where the seventh duration is a duration during which the difference value between the second performance of the third AI model and the second performance of the target object is greater than or equal to a fifteenth threshold;
a ratio of the second performance of the third AI model to the second performance of the target object is less than or equal to a sixteenth threshold;
a seventh number of times is greater than or equal to a seventh number-of-times threshold, where the seventh number of times is a number of times at which the ratio of the second performance of the third AI model to the second performance of the target object is less than or equal to a seventeenth threshold within a seventh preset time period;
an eighth number of times is less than or equal to an eighth number-of-times threshold, where the eighth number of times is a number of times at which the ratio of the second performance of the third AI model to the second performance of the target object is less than or equal to an eighteenth threshold within an eighth preset time period;
an eighth duration is greater than or equal to a seventh time threshold, where the eighth duration is a duration during which the ratio of the second performance of the third AI model to the second performance of the target object is less than or equal to a nineteenth threshold; and
a ninth duration is less than or equal to an eighth time threshold, where the ninth duration is a duration during which the ratio of the second performance of the third AI model to the second performance of the target object is greater than or equal to a twentieth threshold.

For example, the apparatus 500 further includes a third sending module, configured to send replacement information to the second device, where the replacement information is used for indicating information related to the replacement operation.

For example, when the first device is a user equipment, and the second device is a network side device, target information sent by the first device to the second device is carried in one of the following signalings or information:
a layer-1 signaling of a PUCCH;
MSG 1 of a PRACH;
MSG 3 of the PRACH;
MSG A of the PRACH; and
information of a PUSCH.

The target information includes the failure confirmation information, the first information, or the replacement information.

For example, when the first device is a first user equipment, and the second device is a second user equipment, a target message sent by the first device to the second device is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The target information includes the failure confirmation information, the first information, or the replacement information.

For example, when the first device is a user equipment, and the second device is a network side device, second information sent by the second device to the first device is carried in one of the following signalings or information, and the second information is used for indicating the model adjustment operation:
a MAC CE;
a RRC message;
a NAS message;
a management and orchestration message;
user plane data;
DCI;
a SIB;
a layer-1 signaling of a PDCCH;
information of a PDSCH;
MSG 2 of a PRACH;
MSG 4 of the PRACH; and
MSG B of the PRACH.

For example, when the first device is a first user equipment, and the second device is a second user equipment, second information sent by the second device to the first device is carried in one of the following signalings or information, and the second information is used for indicating the model adjustment operation:
an Xn interface signaling;
a PC5 interface signaling;
information of a PSCCH;
information of a PSSCH;
information of a PSBCH;
information of a PSDCH; and
information of a PSFCH.

The apparatus 500 for adjusting a model provided in the embodiments of this application can implement the various processes implemented by the method embodiment shown in FIG. 2 and achieve the same technical effects, details of which are omitted here for brevity.

FIG. 6 is an apparatus for transmitting information according to an embodiment of this application. The apparatus 600 for transmitting information includes:
a first receiving module 601, configured to receive first information sent by a first device, where the first information is used for indicating a model adjustment operation executed by the first device on a first AI model;
or, a first sending module 602, configured to send second information to the first device, where the second information is used for indicating the model adjustment operation executed by the first device on the first AI model.

The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

For example, the apparatus 600 further includes a second receiving module, configured to receive failure confirmation information sent by the first device, where the failure confirmation information is used for indicating failure information of the first AI model.

For example, the failure confirmation information includes at least one of the following:
a failure state of the first AI model;
performance information when the first AI model fails;
a failure cause of the first AI model;
failure time of the first AI model; and
a first duration of the first AI model, where the first duration is a time length from the beginning of the operation of the first AI model to the failure of the first AI model.

For example, the apparatus 600 further includes a third receiving module, configured to receive replacement information sent by the first device. The replacement information is used for indicating information related to a replacement operation executed by the first device.

The replacement operation includes:
when the model adjustment operation includes finetuning the first AI model and switching the first AI model into the second AI model, stopping operating the second AI model, and operating a third AI model, where the third AI model is a model obtained after the first AI model is finetuned;
or,
when the model adjustment operation includes finetuning the first AI model and fallback to the target functional module for operation, stopping operating the target functional module, and operating the third AI model.

For example, when the first device is a user equipment, and the second device is a network side device, target information sent by the first device to the second device is carried in one of the following signalings or information:
a layer-1 signaling of a PUCCH;
MSG 1 of a PRACH;
MSG 3 of the PRACH;
MSG A of the PRACH; and
information of a PUSCH.

The target information includes the failure confirmation information, the first information, or the replacement information.

For example, when the first device is a first user equipment, and the second device is a second user equipment, a target message sent by the first device to the second device is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The target information includes the failure confirmation information, the first information, or the replacement information.

For example, when the first device is a user equipment, and the second device is a network side device, the second information is carried in one of the following signalings or information:
a MAC CE;
a RRC message;
a NAS message;
a management and orchestration message;
user plane data;
DCI;
a SIB;
a layer-1 signaling of a PDCCH;
information of a PDSCH;
MSG 2 of a PRACH;
MSG 4 of the PRACH; and
MSG B of the PRACH.

For example, when the first device is a first user equipment, and the second device is a second user equipment, the second information is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The apparatus 600 for transmitting information provided in the embodiments of this application can implement the various processes implemented by the method embodiment shown in FIG. 3 and achieve the same technical effects, details of which are omitted here for brevity.

The apparatus in the embodiments of this application may be an electronic device, for example, an electronic device having an operating system, or a component in an electronic device, such as an integrated circuit or a chip. The electronic device may be a user equipment or a device other than the user equipment. Exemplarily, the user equipment may include, but is not limited to, the types of the user equipment 11 listed above, and the other device may be a server, a Network Attached Storage (NAS), or the like. The embodiments of this application do not impose a specific limitation on this.

The embodiments of this application further provide a first device, including a processor and a communication interface. The processor is configured to execute a model adjustment operation on a first AI model. The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model. The embodiment of the first device corresponds to the method embodiment shown in FIG. 2, and various implementation processes and implementation modes of the method embodiment described above can be applied to the embodiment of the first device and can achieve the same technical effects.

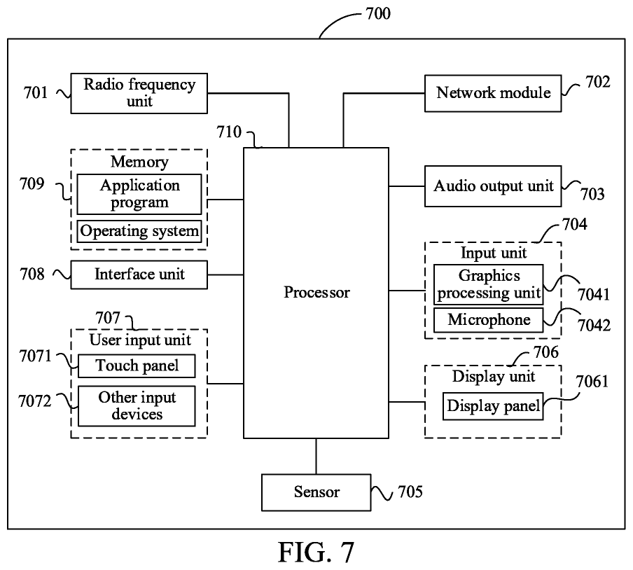

FIG. 7 is a schematic structural diagram of hardware of a user equipment for implementing the embodiments of this application. A first device may be a terminal.

The user equipment 700 includes, but is not limited to: a radio frequency unit 701, a network module 702, an audio output unit 703, an input unit 704, a sensor 705, a display unit 706, a user input unit 707, an interface unit 708, a memory 709, a processor 710, and the like.

Those skilled in the art may understand that the user equipment 700 may further include a power supply (such as a battery) for supplying power to the various components. The power supply may be logically connected to the processor 710 by using a power management system, thereby implementing functions such as charging, discharging, and power consumption management by using the power management system. The structures of the user equipment shown in FIG. 7 constitute no limitation on the user equipment, and the user equipment may include more or fewer components than those shown in the figure, or some components may be combined, or a different component deployment may be used, details of which are omitted here.

It should be understood that in the embodiments of this application, the input unit 704 may include a Graphics Processing Unit (GPU) 7041 and a microphone 7042, and the graphics processing unit 7041 processes image data of static pictures or videos obtained by an image capturing apparatus (such as a camera) in a video capturing mode or an image capturing mode. The display unit 706 may include a display panel 7061. The display panel 7061 may be configured by using a liquid crystal display, an organic light-emitting diode, or the like. The user input unit 707 includes a touch panel 7071 and other input devices 7072. The touch panel 7071 is also referred to as a touch screen. The touch panel 7071 may include two parts: a touch detection apparatus and a touch controller. The other input devices 7072 may include, but is not limited to, a physical keyboard, a function key (such as a volume control key or a switch key), a track ball, a mouse, and a joystick, details of which are omitted here.

In the embodiments of this application, the radio frequency unit 701 receives downlink data from a network side device and transmits the data to the processor 710 for processing. In addition, uplink data is sent to a base station. Generally, the radio frequency unit 701 includes, but is not limited to, an antenna, at least one amplifier, a transceiver, a coupler, a low noise amplifier, a duplexer, and the like.

The memory 709 is configured to store software programs or instructions and various data. The memory 709 may mainly include a program or instruction storage area and a data storage area. The program or instruction storage area may store an operating system, an application program or instructions required by at least one function (for example, a sound playing function and an image display function), and the like. In addition, the memory 709 may include a high-speed random access memory and may further include non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk memory device, a flash memory device, or another non-volatile solid state memory device.

The processor 710 may include one or more processing units. For example, the processor 710 may integrate an application processor and a modem processor. The application processor mainly processes an operating system, a user interface, an application program or instructions, and the like, and the modem processor mainly processes wireless communications, such as a baseband processor. It may be understood that, the modem processor may also not be integrated into the processor 710.

The processor 710 is configured to execute a model adjustment operation on a first AI model. The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

For example, the processor 710 is further configured to determine, based on a preset condition, that the first AI model fails, and executing the model adjustment operation on the first AI model.

The preset condition includes the following: first performance of the first AI model satisfies a first condition, or second performance of the first AI model satisfies a second condition, where an AI model with high first performance is superior to an AI model with low first performance, and an AI model with low second performance is superior to an AI model with high second performance.

For example, the first condition includes one of the following:
the first performance of the first AI model is less than or equal to a first threshold;
a first statistic number of times is greater than or equal to a first preset number-of-times threshold, where the first statistic number of times is a number of times at which the first performance of the first AI model is less than or equal to a second threshold within a first target preset time period;
a second statistic number of times is less than or equal to a second preset number-of-times threshold, where the second statistic number of times is a number of times at which the first performance of the first AI model is greater than or equal to a third threshold within a second target preset time period;
first time is less than or equal to a first time threshold, where the first time is a duration during which the first performance of the first AI model is greater than or equal to a fourth threshold; and
second time is greater than or equal to a second time threshold, where the second time is a duration during which the first performance of the first AI model is less than or equal to a fifth threshold.

For example, the second condition includes one of the following:
the second performance of the first AI model is greater than or equal to a sixth threshold;
a third statistic number of times is greater than or equal to a third preset number-of-times threshold, where the third statistic number of times is a number of times at which the second performance of the first AI model is greater than or equal to a seventh threshold within a third target preset time period;
a fourth statistic number of times is less than or equal to a fourth preset number-of-times threshold, where the fourth statistic number of times is a number of times at which the second performance of the first AI model is less than or equal to an eighth threshold within a fourth target preset time period;
third time is less than or equal to a third time threshold, where the third time is a duration during which the second performance of the first AI model is less than or equal to a ninth threshold; and
fourth time is greater than or equal to a fourth time threshold, where the fourth time is a duration during which the second performance of the first AI model is greater than or equal to a tenth threshold.

For example, the radio frequency unit 701 is configured to send failure confirmation information to a second device when the first AI model fails. The failure confirmation information is used for indicating failure information of the first AI model.

For example, the failure confirmation information includes at least one of the following:
a failure state of the first AI model;
performance information when the first AI model fails;
a failure cause of the first AI model;
failure time of the first AI model; and
a first duration of the first AI model, where the first duration is a time length from the beginning of the operation of the first AI model to the failure of the first AI model.

For example, the model adjustment operation is determined by the first device, or indicated by a second device.

For example, the radio frequency unit 701 is further configured to, when the model adjustment operation is determined by the first device, send first information to the second device, where the first information is used for indicating the model adjustment operation executed by the first device.

For example, the processor 710 is further configured to execute a replacement operation based on a triggering condition. The replacement operation includes:
when the model adjustment operation includes finetuning the first AI model and switching the first AI model into the second AI model, stopping operating the second AI model, and operating a third AI model, where the third AI model is a model obtained after the first AI model is finetuned;
or,
when the model adjustment operation includes finetuning the first AI model and fallback to the target functional module for operation, stopping operating the target functional module, and operating the third AI model.

For example, the triggering condition includes one of the following:
a difference value between first performance of the third AI model and first performance of a target object is greater than or equal to a first threshold, where the target object is the second AI model or the target functional module, and an AI model with high first performance is superior to an AI model with low first performance;
a first number of times is greater than or equal to a first number-of-times threshold, where the first number of times is a number of times at which the difference value between the first performance of the third AI model and the first performance of the target object is greater than or equal to a second threshold within a first preset time period;
a second number of times is less than or equal to a second number-of-times threshold, where the second number of times is a number of times at which the difference value between the first performance of the third AI model and the first performance of the target object is less than or equal to a third threshold within a second preset time period;
a second duration is greater than or equal to a first time threshold, where the second duration is a duration during which the difference value between the first performance of the third AI model and the first performance of the target object is greater than or equal to a fourth threshold;
a third duration is less than or equal to a second time threshold, where the third duration is a duration during which the difference value between the first performance of the third AI model and the first performance of the target object is less than or equal to a fifth threshold;
a ratio of the first performance of the third AI model to the first performance of the target object is greater than or equal to a sixth threshold;
a third number of times is greater than or equal to a third number-of-times threshold, where the third number of times is a number of times at which the ratio of the first performance of the third AI model to the first performance of the target object is greater than or equal to a seventh threshold within a third preset time period;
a fourth number of times is less than or equal to a fourth number-of-times threshold, where the fourth number of times is a number of times at which the ratio of the first performance of the third AI model to the first performance of the target object is less than or equal to an eighth threshold within a fourth preset time period;
a fourth duration is greater than or equal to a third time threshold, where the fourth duration is a duration during which the ratio of the first performance of the third AI model to the first performance of the target object is greater than or equal to a ninth threshold; and
a fifth duration is less than or equal to a fourth time threshold, where the fifth duration is a duration during which the ratio of the first performance of the third AI model to the first performance of the target object is less than or equal to a tenth threshold.

For example, the triggering condition includes one of the following:
a difference value between second performance of the third AI model and second performance of a target object is less than or equal to an eleventh threshold, where the target object is the second AI model or the target functional module, and an AI model with low second performance is superior to an AI model with high second performance;
a fifth number of times is greater than or equal to a fifth number-of-times threshold, where the fifth number of times is a number of times at which the difference value between the second performance of the third AI model and the second performance of the target object is less than or equal to a twelfth threshold within a fifth preset time period;
a sixth number of times is less than or equal to a sixth number-of-times threshold, where the sixth number of times is a number of times at which the difference value between the second performance of the third AI model and the second performance of the target object is greater than or equal to a thirteenth threshold within a sixth preset time period;
a sixth duration is greater than or equal to a fifth time threshold, where the sixth duration is a duration during which the difference value between the second performance of the third AI model and the second performance of the target object is greater than or equal to a fourteenth threshold;
a seventh duration is less than or equal to a sixth time threshold, where the seventh duration is a duration during which the difference value between the second performance of the third AI model and the second performance of the target object is greater than or equal to a fifteenth threshold;
a ratio of the second performance of the third AI model to the second performance of the target object is less than or equal to a sixteenth threshold;
a seventh number of times is greater than or equal to a seventh number-of-times threshold, where the seventh number of times is a number of times at which the ratio of the second performance of the third AI model to the second performance of the target object is less than or equal to a seventeenth threshold within a seventh preset time period;
an eighth number of times is less than or equal to an eighth number-of-times threshold, where the eighth number of times is a number of times at which the ratio of the second performance of the third AI model to the second performance of the target object is less than or equal to an eighteenth threshold within an eighth preset time period;
an eighth duration is greater than or equal to a seventh time threshold, where the eighth duration is a duration during which the ratio of the second performance of the third AI model to the second performance of the target object is less than or equal to a nineteenth threshold; and
a ninth duration is less than or equal to an eighth time threshold, where the ninth duration is a duration during which the ratio of the second performance of the third AI model to the second performance of the target object is greater than or equal to a twentieth threshold.

For example, the radio frequency unit 701 is further configured to send replacement information to the second device, where the replacement information is used for indicating information related to the replacement operation.

For example, when the first device is a user equipment, and the second device is a network side device, target information is carried in one of the following signalings or information:
a layer-1 signaling of a PUCCH;
MSG 1 of a PRACH;
MSG 3 of the PRACH;
MSG A of the PRACH; and
information of a PUSCH.

The target information includes the failure confirmation information, the first information, or the replacement information.

For example, when the first device is a first user equipment, and the second device is a second user equipment, a target message is carried in one of the following signalings or information:
an Xn interface signaling;
a PC5 interface signaling;
information of a PSCCH;
information of a PSSCH;
information of a PSBCH;
information of a PSDCH; and
information of a PSFCH.

The target information includes the failure confirmation information, the first information, or the replacement information.

For example, when the first device is a user equipment, and the second device is a network side device, second information is carried in one of the following signalings or information, and the second information is used for indicating the model adjustment operation:
a MAC CE;
a RRC message;
a NAS message;
a management and orchestration message;
user plane data;
DCI;
a SIB;
a layer-1 signaling of a PDCCH;
information of a PDSCH;
MSG 2 of the PRACH;
MSG 4 of the PRACH; and
MSG B of the PRACH.

For example, when the first device is a first user equipment, and the second device is a second user equipment, second information is carried in one of the following signalings or information, and the second information is used for indicating the model adjustment operation:
an Xn interface signaling;
a PC5 interface signaling;
information of a PSCCH;
information of a PSSCH;
information of a PSBCH;
information of a PSDCH; and
information of a PSFCH.

The user equipment 700 provided in the embodiments can implement the various processes implemented by the method embodiment shown in FIG. 2 and achieve the same technical effects, details of which are omitted here for brevity.

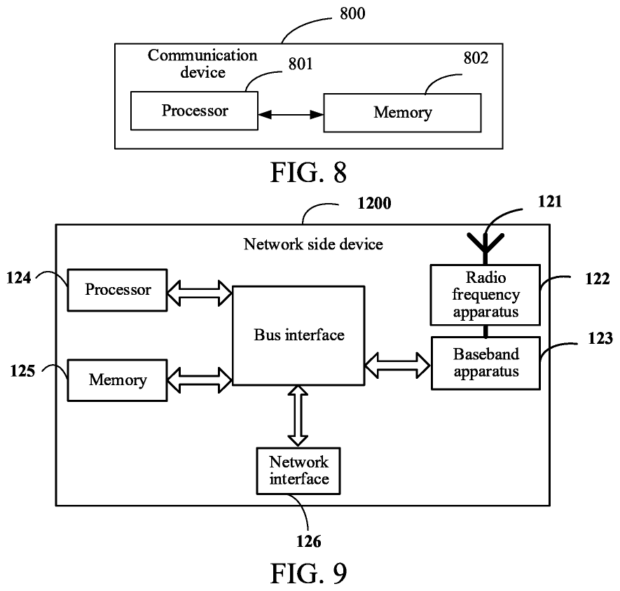

For example, as shown in FIG. 8, the embodiments of this application further provide a communication device 800, including a processor 801 and a memory 802. The memory 802 stores programs or instructions runnable on the processor 801. The programs or instructions, when executed by the processor 801, implement the various steps of the above method embodiment shown in FIG. 2 or FIG. 3 and can achieve the same technical effects, details of which are omitted here for brevity.

The embodiments of this application further provide a second device, including a processor and a communication interface. The communication interface is configured to receive first information sent by a first device, where the first information is used for indicating a model adjustment operation executed by the first device on a first AI model; or, send second information to the first device, where the second information is used for indicating the model adjustment operation executed by the first device on the first AI model.

The model adjustment operation includes one of the following:
finetuning the first AI model;
switching the first AI model into a second AI model;
fallback to a target functional module for operation, where the target functional module is a module that does not use an AI model;
finetuning the first AI model, and switching the first AI model into a second AI model;
finetuning the first AI model, and fallback to the target functional module for operation; and
stopping execution of a first function, where the first function is a function that is completed by the first AI model.

The embodiment of the second device corresponds to the method embodiment shown in FIG. 3, and various implementation processes and implementation modes of the method embodiment described above can be applied to the embodiment of the second device and can achieve the same technical effects.

For example, the embodiments of this application further provide a network side device. As shown in FIG. 9, the network side device 1200 includes: an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121 and sends the received information to the baseband apparatus 123 for processing. In a downlink direction, the baseband apparatus 123 processes information to be sent and sends the information to the radio frequency apparatus 122. The radio frequency apparatus 122 processes the received information and sends the information out via the antenna 121.

The method performed by the network side device in the above embodiment may be implemented in the baseband apparatus 123. The baseband apparatus 123 includes a baseband processor.

The baseband apparatus 123 may include, for example, at least one baseband board. Multiple chips are arranged on the baseband board. As shown in FIG. 9, one of the chips is, for example, a baseband processor, connected to the memory 125 through a bus interface to call a program in the memory 125 to perform the operations of the network device shown in the above method embodiment.

The network side device may further include a network interface 126. The interface is, for example, a common public radio interface (common public radio interface, CPRI).

For example, the network side device 1200 of the embodiments of this application further includes: instructions or programs stored on the memory 125 and runnable on the processor 124. The processor 124 calls the instructions or programs in the memory 125 to perform the method performed by the various modules shown in FIG. 6 and achieve the same technical effects, details of which are omitted here for brevity.

The embodiments of this application further provide a readable storage medium. The readable storage medium stores programs or instructions. The programs or instructions, when executed by a processor, implement the various processes of the above method embodiments shown in FIG. 2 or FIG. 3 and can achieve the same technical effects, details of which are omitted here for brevity.

The processor is the processor in the user equipment in the embodiments described above. The readable storage medium includes a computer-readable storage medium, for example, a computer ROM, a Random Access Memory (RAM), a magnetic disc, an optical disc, or the like.

The embodiments of this application further provide a chip. The chip includes a processor and a communication interface. The communication interface is coupled to the processor. The processor is configured to run programs or instructions to implement the various processes of the above method embodiment shown in FIG. 2 or FIG. 3, and can achieve the same technical effects, details of which are omitted here for brevity.

It should be understood that the chip mentioned in the embodiments of this application may also be referred to as a system level chip, a system chip, a chip system, or a system-on-chip.

The embodiments of this application further provide a computer program/program product. The computer program/program product is stored in a storage medium. The computer program/program product, when executed by at least one processor, implements the various processes of the above method embodiment of FIG. 2 or FIG. 3, and can achieve the same technical effects, details of which are omitted here for brevity.

The embodiments of this application further provide a communication system, including: a first device and a second device. The first device may be configured to execute the steps of the method embodiment as shown in FIG. 2. The second device may be configured to execute the steps of the method embodiment as shown in FIG. 3.

Those of ordinary skill in the art may notice that the exemplary units and algorithm steps described with reference to the embodiments disclosed in this specification can be implemented in electronic hardware, or a combination of computer software and electronic hardware. Whether the functions are executed in hardware or software depends on particular applications and design constraint conditions of the technical solutions. A person skilled in the art may use different methods to implement the described functions for each particular application, but such implementation is not to be considered beyond the scope of this disclosure.

A person skilled in the art may clearly understand that, for convenience and conciseness of description, for specific working processes of the above systems, apparatuses and units, reference may be made to the corresponding processes in the foregoing method embodiments, and details of which are omitted here.

In the embodiments provided in this application, it should be understood that the disclosed system, apparatuses, and methods may be implemented in other manners. For example, the apparatus embodiments described above are merely examples. For example, the unit division is merely a logical function division and may be another division during actual implementation. For example, multiple units or components may be combined or integrated into another system, or some features may be ignored or not performed. In addition, the shown or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units are selected according to actual needs to achieve the objective of the solution of this embodiment.

In addition, functional units in the various embodiments of this disclosure may be integrated into one processing unit, or each of the units may be physically separated, or two or more units may be integrated into one unit.

The functions, if implemented in the form of software functional units and sold or used as stand-alone products, may be stored in a computer-readable storage medium. Based on such an understanding, the technical solutions of this disclosure essentially, or the part contributing to the related technology, or some of the technical solutions may be presented in the form of a software product. The computer software product is stored in a storage medium, and includes several instructions for enabling a computer device (which may be a personal computer, a server, a network device, or the like) to execute all or some of the steps of the methods of the various embodiments of this disclosure. The foregoing storage medium includes: various media that can store program codes, such as a USB flash disk, a mobile hard disk drive, an ROM, an RAM, a magnetic disk, an optical disc, or the like.

A person of ordinary skill in the art may understand that all or some of the procedures of the methods in the above embodiments may be implemented by a computer program controlling relevant hardware. The program may be stored in a computer-readable storage medium. When the program is executed, the procedures of the above method embodiments are executed. The storage medium may be a magnetic disc, an optical disc, a ROM, a RAM, or the like.

It should be noted that, the terms “include”, “comprise”, or any other variations thereof herein are intended to cover a non-exclusive inclusion, so that a process, method, article, or apparatus including a series of elements not only includes those elements, but also includes other elements not specifically listed, or includes inherent elements of this process, method, article, or apparatus. An element proceeded by “includes a . . . ” does not, without more constraints, preclude the existence of additional identical elements in the process, method, article, or apparatus that includes the element. In addition, it should be noted that the scope of the methods and apparatuses in the embodiments of this application is not limited to performing functions in the sequence shown or discussed, but may also include performing functions in a substantially simultaneous manner or in an opposite sequence according to the functions involved. For example, the methods described may be executed in a different order than that described, and various steps may also be added, omitted, or combined. In addition, features described with reference to some examples may be combined in other examples.

According to the descriptions in the above implementations, a person skilled in the art may clearly learn that the method according to the above embodiment may be implemented by relying on software and an essential commodity hardware platform or by using hardware, but the former is a better implementation in most cases. Based on such an understanding, the technical solutions of this application essentially or parts contributing to the related art may be implemented in a form of a computer software product. The computer software product is stored in a storage medium (such as an ROM/RAM, a magnetic disk, or an optical disc) and includes several instructions for enabling a user equipment (which may be a mobile phone, a computer, a server, an air conditioner, a network device, or the like) to perform the methods described in the various embodiments of this application.

The embodiments of this application have been described above with reference to the accompanying drawings. However, this application is not limited to the specific implementations described above. The specific implementations described above are merely examples and not limitative. Those of ordinary skill in the art may make various forms under the teaching of this application without departing from the spirit of this application and the protection scope of the claims, and these forms shall all fall within the protection of this application.

What is claimed is:

1. A method for adjusting a model, comprising:
executing, by a first device, a model adjustment operation on a first Artificial Intelligence (AI) model, wherein the model adjustment operation comprises one of the following:
finetuning the first AI model;
switching the first AI model into a second AI model;
falling back to a target functional module for operation, wherein the target functional module is a module that does not use an AI model;
finetuning the first AI model, and switching the first AI model into a second AI model;
finetuning the first AI model, and falling back to the target functional module for operation; or
stopping execution of a first function, wherein the first function is a function that is completed by the first AI model.

2. The method according to claim 1, wherein the executing, by the first device, the model adjustment operation on the first AI model comprises:
determining, by the first device based on a preset condition, that the first AI model fails, and executing the model adjustment operation on the first AI model;
the preset condition comprises the following: first performance of the first AI model satisfies a first condition, or second performance of the first AI model satisfies a second condition, wherein an AI model with high first performance is superior to an AI model with low first performance, and an AI model with low second performance is superior to an AI model with high second performance.

3. The method according to claim 2, wherein the first condition comprises one of the following:
the first performance of the first AI model is less than or equal to a first threshold;
a first statistic number of times is greater than or equal to a first preset number-of-times threshold, wherein the first statistic number of times is a number of times at which the first performance of the first AI model is less than or equal to a second threshold within a first target preset time period;
a second statistic number of times is less than or equal to a second preset number-of-times threshold, wherein the second statistic number of times is a number of times at which the first performance of the first AI model is greater than or equal to a third threshold within a second target preset time period;
first time is less than or equal to a first time threshold, wherein the first time is a duration during which the first performance of the first AI model is greater than or equal to a fourth threshold; or
second time is greater than or equal to a second time threshold, wherein the second time is a duration during which the first performance of the first AI model is less than or equal to a fifth threshold.

4. The method according to claim 2, wherein the second condition comprises one of the following:
the second performance of the first AI model is greater than or equal to a sixth threshold;
a third statistic number of times is greater than or equal to a third preset number-of-times threshold, wherein the third statistic number of times is a number of times at which the second performance of the first AI model is greater than or equal to a seventh threshold within a third target preset time period;
a fourth statistic number of times is less than or equal to a fourth preset number-of-times threshold, wherein the fourth statistic number of times is a number of times at which the second performance of the first AI model is less than or equal to an eighth threshold within a fourth target preset time period;
third time is less than or equal to a third time threshold, wherein the third time is a duration during which the second performance of the first AI model is less than or equal to a ninth threshold; or
fourth time is greater than or equal to a fourth time threshold, wherein the fourth time is a duration during which the second performance of the first AI model is greater than or equal to a tenth threshold.

5. The method according to claim 2, further comprising:
sending, by the first device, failure confirmation information to a second device when the first AI model fails, wherein the failure confirmation information is used for indicating failure information of the first AI model.

6. The method according to claim 5, wherein the failure confirmation information comprises at least one of the following:
a failure state of the first AI model;
performance information when the first AI model fails;
a failure cause of the first AI model;
failure time of the first AI model; or
a first duration of the first AI model, wherein the first duration is a time length from the beginning of the operation of the first AI model to the failure of the first AI model.

7. The method according to claim 1, wherein the model adjustment operation is determined by the first device, or indicated by a second device.

8. The method according to claim 7, wherein after the executing, by a first device, a model adjustment operation on a first AI model, the method further comprises:
when the model adjustment operation is determined by the first device, sending, by the first device, first information to the second device, wherein the first information is used for indicating the model adjustment operation executed by the first device.

9. The method according to claim 1, wherein after the executing, by the first device, the model adjustment operation on the first AI model, the method further comprises:
executing, by the first device, a replacement operation based on a triggering condition;
or,
sending, by the first device, third information to the second device based on the triggering condition; receiving, by the first device, indication information sent by the second device; and determining, by the first device according to the indication information, whether to execute the replacement operation, wherein the third information is used for indicating that the first device satisfies a condition for executing the replacement operation, and the indication information is used for indicating the first device to execute or not execute the replacement operation.

10. The method according to claim 9, wherein the replacement operation comprises:
when the model adjustment operation comprises finetuning the first AI model and switching the first AI model into the second AI model, stopping operating the second AI model, and operating a third AI model, wherein the third AI model is a model obtained after the first AI model is finetuned;
or,
when the model adjustment operation comprises finetuning the first AI model and falling back to the target functional module for operation, stopping operating the target functional module, and operating the third AI model.

11. The method according to claim 9, wherein after the executing, by the first device, the replacement operation based on the triggering condition, the method further comprises:
sending, by the first device, replacement information to the second device, wherein the replacement information is used for indicating information related to the replacement operation.

12. The method according to claim 5, wherein when the first device is a user equipment, and the second device is a network side device, target information sent by the first device to the second device is carried in one of the following signalings or information:
a layer-1 signaling of a Physical Uplink Control Channel (PUCCH);
MSG 1 of a Physical Random Access Channel (PRACH);
MSG 3 of the PRACH;
MSG A of the PRACH; or
information of a Physical Uplink Shared Channel (PUSCH),
wherein the target information comprises the failure confirmation information, first information, third information, or replacement information.

13. The method according to claim 5, wherein when the first device is a first user equipment, and the second device is a second user equipment, a target message sent by the first device to the second device is carried in one of the following signalings or information:
an Xn interface signaling;
a PC5 interface signaling;
information of a Physical Sidelink Control Channel (PSCCH);
information of a Physical Sidelink Shared Channel (PSSCH);
information of a Physical Sidelink Broadcast Channel (PSBCH);
information of a Physical Sidelink Siscovery Channel (PSDCH); or
information of a Physical Sidelink Feedback Channel (PSFCH),
wherein the target information comprises the failure confirmation information, first information, third information, or replacement information.

14. The method according to claim 7, wherein when the first device is a user equipment, and the second device is a network side device, second information or indication information sent by the second device to the first device is carried in one of the following signalings or information, and the second information is used for indicating the model adjustment operation:
a Media Access Control Control Element (MAC CE);
a Radio Resource Control (RRC) message;
a Non-Access-Stratum (NAS) message;
a management and orchestration message;
user plane data;
Downlink Control Information (DCI);
a System Information Block (SIB);
a layer-1 signaling of a Physical Downlink Control Channel (PDCCH);
information of a Physical Downlink Shared Channel (PDSCH);
MSG 2 of a PRACH;
MSG 4 of the PRACH; or
MSG B of the PRACH.

15. The method according to claim 7, wherein when the first device is a first user equipment, and the second device is a second user equipment, second information or indication information sent by the second device to the first device is carried in one of the following signalings or information, and the second information is used for indicating the model adjustment operation:
an Xn interface signaling;
a PC5 interface signaling;
information of a PSCCH;
information of a PSSCH;
information of a PSBCH;
information of a PSDCH; or
information of a PSFCH.

16. A method for transmitting information, comprising:
receiving, by a second device, first information sent by a first device, wherein the first information is used for indicating a model adjustment operation executed by the first device on a first AI model; or
sending, by the second device, second information to the first device, wherein the second information is used for indicating the model adjustment operation executed by the first device on the first AI model,
wherein the model adjustment operation comprises one of the following:
finetuning the first AI model;
switching the first AI model into a second AI model;
falling back to a target functional module for operation, wherein the target functional module is a module that does not use an AI model;
finetuning the first AI model, and switching the first AI model into a second AI model;
finetuning the first AI model, and falling back to the target functional module for operation; or
stopping execution of a first function, wherein the first function is a function that is completed by the first AI model.

17. The method according to claim 16, further comprising:
receiving, by the second device, failure confirmation information sent by the first device, wherein the failure confirmation information is used for indicating failure information of the first AI model.

18. The method according to claim 16, further comprising:
receiving, by the second device, replacement information sent by the first device, wherein the replacement information is used for indicating information related to a replacement operation executed by the first device; or
receiving, by the second device, third information sent by the first device; and
sending, by the second device, indication information to the first device based on the third information, wherein the third information is used for indicating that the first device satisfies a condition for executing the replacement operation, and the indication information is used for indicating the first device to execute or not execute the replacement operation.

19. The method according to claim 16, wherein when the first device is a user equipment, and the second device is a network side device, target information sent by the first device to the second device is carried in one of the following signalings or information:
a layer-1 signaling of a PUCCH;
MSG 1 of a PRACH;
MSG 3 of the PRACH;
MSG A of the PRACH; or
information of a PUSCH,
wherein the target information comprises the failure confirmation information, the first information, or replacement information.

20. A first device, comprising a processor and a memory storing instructions, wherein the instructions, when executed by the processor, cause the processor to perform operations comprising:
executing a model adjustment operation on a first Artificial Intelligence (AI) model, wherein the model adjustment operation comprises one of the following:
finetuning the first AI model;
switching the first AI model into a second AI model;
falling back to a target functional module for operation, wherein the target functional module is a module that does not use an AI model;
finetuning the first AI model, and switching the first AI model into a second AI model;
finetuning the first AI model, and falling back to the target functional module for operation; or
stopping execution of a first function, wherein the first function is a function that is completed by the first AI model.
